(19) United States
(12) Patent Application Publication
(10) Pub. No.: US 2006/0101344 A1
(43) Pub. Date: May 11, 2006

(54) Image forming apparatus

(76) Inventor: Fujio Tabata, Osaka (JP)

Correspondence Address: DITTHAVONG & CARLSON, P.C., Suite A, 10507 Braddock Road, Fairfax, VA, 22032, US

(21) Appl. No.: 11/269,235

(22) Filed: Nov. 8, 2005

(30) Foreign Application Priority Data
Nov. 8, 2004 (JP) JP2004-323890

(51) Int. Cl. H04N 5/44

(52) U.S. Cl. 715/761; 715/718

(57) ABSTRACT

An image forming apparatus, which display units the information relating to the job of the selected function on a first display screen of a display unit 4 when one of different functions is selected; changes over the display unit 4 to a second display screen including a first display area and a second display area when the job of another function that is not selected is inputted; and display units the information relating to the job of the selected function on the first display area and the information relating to the inputted job of the function not selected on the second display area.

### BACKGROUND OF THE INVENTION

1. Field of the Invention

The present invention relates to an image forming apparatus, and in particular, to an image forming apparatus such as a multi functional printer that can execute jobs of a copy machine, a facsimile, a scanner, and the like.

2. Description of the Related Art

An image forming apparatus such as a multi functional printer, for example, can execute a job of a copy function, a facsimile function, a scanner function, and a printer function by operating a changeover switch and selecting any of these functions. Further, if a new job for printing by having the image forming apparatus function as a printer is given from a different personal computer (hereinafter, referred to as a PC) while the copy function is selected and executed, for example, this new job is stored in a memory within the image forming apparatus.

If a user switches over from the copy function to the printer function with the changeover switch, the user can confirm that the job to be printed is transmitted and stored in the memory, and the job can be printed out by executing the printer function. Various methods have been proposed for processing the jobs stored in the memory so far.

Japanese Patent Laid-Open application No. 2002-366320 discloses a job processing apparatus wherein, the processing order may be changed freely even after a plurality of jobs are stored and being processed in series.

Japanese Patent Laid-Open application No. 2003-94774 discloses an image forming apparatus that displays, on a liquid crystal panel, a list of documents each including image data of each document as a stored job and a print mode such as print format set corresponding to the document, and prints any of the listed documents by selecting the document or prints listed documents in a selected order.

In the conventional image forming apparatus, if a job is transmitted while a different job is executed, the user cannot confirm the transmission of the job unless the user switches the panel to the function for executing the transmitted job. The job processing apparatus described in JP-A-2002-366320 only changes the order of the stored jobs to be outputted, and the image forming apparatus described in JP-A-2003-94774 simply lists the documents so as to print the documents either in single-side printing or double-side printing.

Thus, even if there is facsimile data incoming while the copy job is executed, it is not possible for the user to know it immediately.

### SUMMARY OF THE INVENTION

An object of the present invention is to provide an image forming apparatus which allows a user to immediately know that a job of one function is transmitted when a job of another function is being executed.

In the present invention, an image forming apparatus capable of processing jobs of different functions includes a display unit that is switchable between a first screen having only one display area and a second screen having a first display area and a second display area; and a control unit that switches the display unit, when one of the different functions is executed, to the first screen so as to display a piece of information relating to a job of the selected function, and when a job of a function that is not selected is inputted, switches the display unit to the second screen so as to display the piece of information relating to the job of the selected function on the first display area, and another piece of information relating to the inputted job of the not-selected function on the second display area.

According to this invention, in the image forming apparatus for processing the jobs of the different functions, when one of the different functions is selected, the information relating to the selected function is displayed on the first display screen of the display unit, and when the job of another function that is not selected is inputted, the information relating to this job is displayed on the second display area of the display unit. Therefore, it is easily possible for the user to know that the job of the function that is not selected is inputted by viewing the display unit of the second display area and the user may immediately carry out the subsequent processing.

Preferably, the control unit switches the display unit to the second screen so as to display pieces of information relating to jobs of different functions respectively on the first display area and the second display area, and when the job of the not-selected function is inputted, the piece of information displayed on the second display area is changed over to a piece of information relating to the inputted job.

Preferably, the control unit controls the display unit so that every time the job of the not-selected function is inputted, the inputted job of the not-selected function on the second display area.

The image forming apparatus according to the present invention further includes job designation unit that designates one of jobs that are displayed on the second display area, and the control unit, in response to the designation of the job from the job designation unit, stops the processing of the job that is currently being executed and performs interruption processing of the designated job.

### BRIEF DESCRIPTION OF THE DRAWINGS

FIG. 1 is a block diagram of an image forming apparatus according to an embodiment of the present invention;

FIGS. 2A and 2B are view showing a display screen of a display unit; and

FIG. 3 is a flowchart showing an operation of a control unit in accordance with the present invention.

### DESCRIPTION OF THE PREFERRED EMBODIMENT

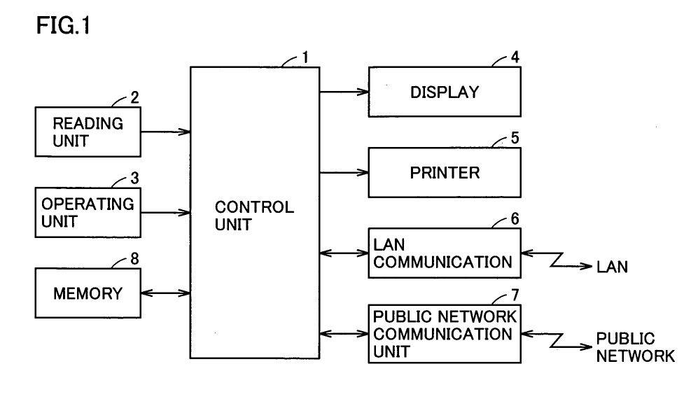

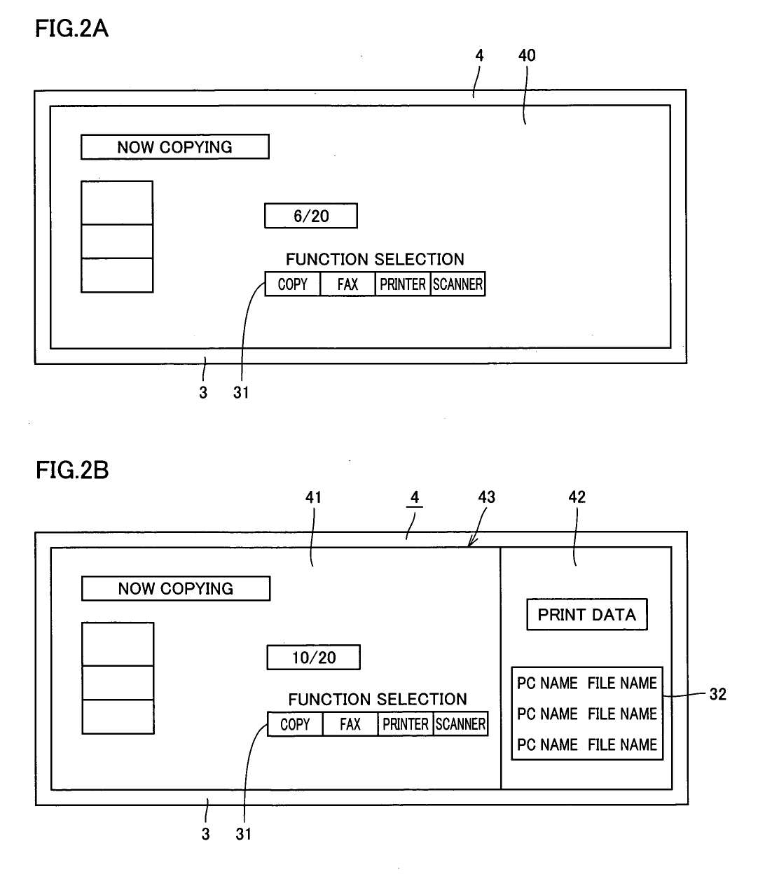

FIG. 1 is a block diagram of an image forming apparatus, such as a multi functional printer, according to an embodiment of the present invention, and FIG. 2 is a view showing a display screen of a display unit of the image forming apparatus.

With reference to FIG. 1, a control unit 1 is connected to a reading unit 2, an operation unit 3, a display unit 4, a printer 5, a LAN communication unit 6, a public network communication unit 7, and a memory 8 and controls these units. The reading unit 2 reads an image from an original when a job is executed by the image forming apparatus as the copy machine, the transmitter of the facsimile, and the scanner.

The display unit 4 is composed of, for example, a color LCD or the like having the display area in a relatively large size, and the display screen of the display unit 4 is configured so as to be switched between a first display screen 40 as shown in FIG. 2A and a second display screen 43 that displays at least two display areas of a first display area 41 and a second display area 42 at the same time. On the first display screen 40 or the first display area 41 of the second display screen 43, the information relating to a job of a function currently being executed is displayed. For example, when the image forming apparatus is executing the function as the copy machine, the indication of “now copying”, and the information of “the number of copied” and “the number of copies” that has been set are displayed as 6/20 on the screen.

The second display area 42 is narrower than the first display area 41, for example, about ⅓ of the first display area 41, in order to avoid any problem in information displayed on the first display area 41. When a job of another function that is not selected to be executed by the image forming apparatus is transmitted, the information relating to this job is displayed on the second display area 42. For example, according to the example shown in FIG. 2B, when the image forming apparatus functions as the copy machine, the second display area 42 indicates that the print data is transmitted as the job from the PC and the information including a PC name and a file name is displayed in a list on the second display area 42. The information displayed on the screen can be used as the job designation switch, which is described later.

In the meantime, as an initial basic screen, on the first display area 41, for example, the information relating to the job of the function of the copy machine may be displayed, and on the second display area 42, for example, the information relating to the job of the function of the facsimile may be displayed in parallel. Thereby, without changing over the functions by a function selecting switch 31, any of the copy machine and the facsimile can immediately function. If the job of the other function that is not selected is inputted, the second display area 42 may be changed over from the display unit of the facsimile into the display of the inputted job.

The operation unit 3 is used for the user to input the data that is needed in each job and to set the function. For example, the operation unit 3 is composed of a touch panel to be arranged on the display unit 4. As shown in FIGS. 2A and 2B, the function selecting switch 31 for selecting any function of the copy machine, the facsimile, the printer, and the scanner is provided on the touch panel.

By selecting any function of the copy machine, the facsimile, the printer, and the scanner by the function selecting switch 31, the job of the selected function can be executed. Further, on the operation unit 3, a job designation switch 32 as the job designation unit is provided, which designates the interruption processing of the job displayed on the second display area 42. If the user operates this job designation switch 32, the processing of the job of the function that has been executed at present is stopped, and the processing of the designated job is executed with priority from among the jobs of the displayed functions. the contents of the job may be displayed when the job designation switch 32 is operated.

The printer 5 prints the job when the image forming apparatus is operated to function as the copy machine, the receiver of the facsimile, and the printer. The LAN communication unit 6 receives the job to be transmitted from the PC via a LAN line or transmits the job read by the reading unit 2 when the image forming apparatus is operated as the scanner for the PC connected to the LAN line.

The public network communication unit 7 transmits or receives the facsimile data to and from a public network when the image forming apparatus functions as the facsimile. The memory 8 stores the data of the job to be transmitted through the LAN line or the public network. In the meantime, the data of the job read by the reading unit 2 may be stored in the memory 8 as required.

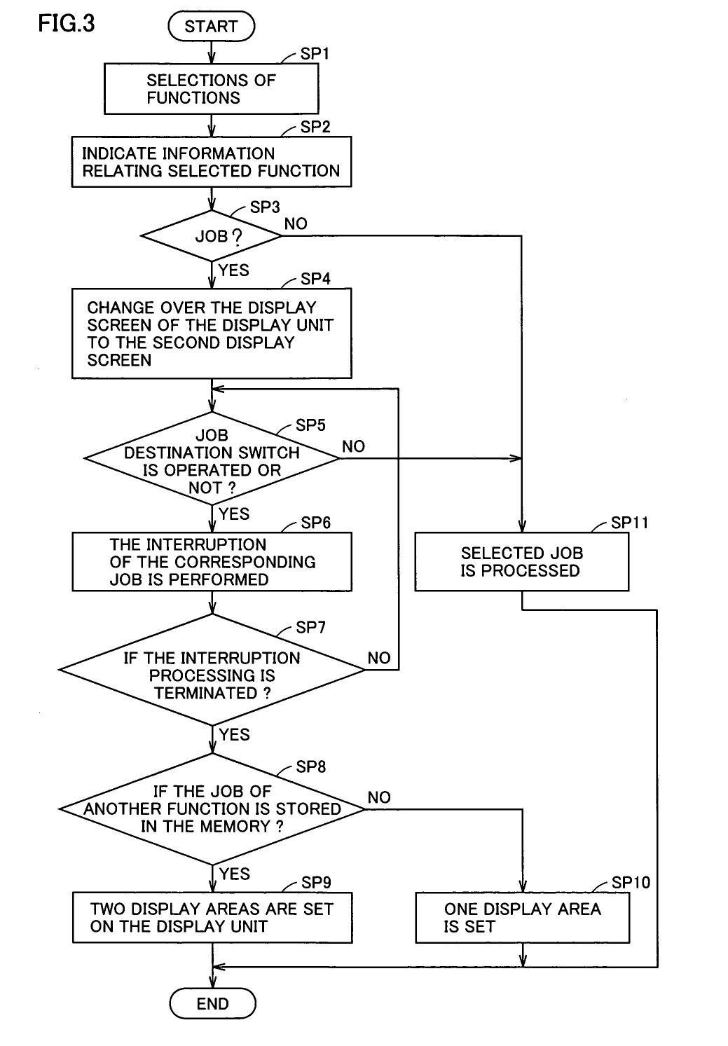

FIG. 3 is a flow chart showing the operation of the control unit 1 according to one embodiment of the present invention. The user selects the function of the image forming apparatus by operating switch 31, and for example, the user selects the copy function. In step (in the drawing, abbreviated as SP) SP1, the control unit 1 determines which function is selected. When it is determined that the copy function is selected in step SP2, the display unit 4 is changed over to be the first display screen 40 as shown in FIG. 2A to display the information about the copy unit thereon. According to this example, the information indicating “now copying” and the number of copying are displayed, and the number of copy is updated every time a copy is made.

In this case, if the job to be printed, for example, from the PC is inputted through the LAN line via the LAN network communication unit 7, the control unit 1 determines if the job of the function not selected is inputted or not in step SP3. It is determined that the job of the function not selected is inputted, the control unit 1 stores the data of that job in the memory 8 and in step S4, changes over the display screen of the display unit 4 to the second display screen 43 as shown in FIG. 2B. Then, the control unit 1 displays the information about the selected copy function on the first display area 41 and displays the fact that the job is inputted from the PC on the second display area 42.

This information is the data with respect to the job of the function that is not selected by the function selecting switch 31 and in this information, the PC name and the file name are displayed. In this case, if the jobs are inputted from other PCs, these jobs are displayed on the second display area 42 as a list.

The user can know that the job is the one for the printing function of the apparatus when the user sees that indication. Then, when determining that the print job should be made by the printer 5, the user designates the corresponding job by operating the job designation switch 32. When it is determined that the job designation switch 32 is operated in step SP5, the interruption processing of the corresponding job is performed in step SP6. More specifically, the data of the corresponding job is read from the memory 8 and prints are made by the printer 5. It is also preferable that the data read from the memory 8 is displayed on the first display area 41 and the user checks the contents, and then the processing of the printer 5 is carried out.

In step SP7, It is determined if the interruption processing is terminated. If the interruption processing for a plurality of jobs is specified, the processing of steps SP5, 6, and 7 is repeated. If the interruption processing is terminated, it is determined if the job is stored in the memory 8 or not (SP8). If it is determined that the job is stored in the memory 8 YES in SP8), two display areas are set on the display unit 4 in SP9 and the information of the selected function is displayed on the first display area 41 and the information relating to the job stored in the memory 8 is displayed on the second display area 42.

If the job of the function other than the selected function is not stored in the memory 8, the display area of the display unit 4 is changed to the first screen 40 in step SP10, the information about the selected function only is displayed.

In the meantime, when it is determined that the job of the other function is not inputted in the step SP3, or it is determined that the job designation switch 32 is not operated in the step SP5, the job of the function that has been selected at present is processed in step SP11.

Therefore, according to this embodiment, when the job of the function that is not selected is inputted, the display unit 4 is changed over into two-screen display, and the information relating to the job of the function that has been selected at present is displayed on the first display area 41 and the fact that the job of the function that is not selected is inputted is displayed on the second display area 42, so that the user can easily understand if the jobs that are not selected are accumulated or not.

In addition, by designating the inputted job by the job designation switch 32, the user also can know the contents of this job and the user can easily retrieve the accumulated jobs.

Further, for example, in the case that a large amount of copies are made without waiting for termination of that job, the user can interrupt the copy operation and immediately can process the accumulated jobs.

Moreover, according to the above-described embodiment, two display areas 41 and 42 are arranged in the display unit 4, however, the present invention is not limited to this and it is also contemplated that two display units are separately provided, the information relating to the job of the selected function is displayed on one display unit, and the inputted job of the function that is not selected is displayed on the other display unit.

In addition, it is also possible to notify the user the fact that the job of other function that has not been executed at present is inputted by lighting a light-emitting diode or the like.

The embodiment of the present invention is described with reference to the drawings as above. However, the present invention is not limited to the illustrated embodiment. Various modifications can be made within the same scope as the present invention or in the equivalent scope.

What is claimed is:

1. An image forming apparatus capable of processing jobs of different functions, comprising:
a display unit that is switchable between a first screen having only one display area and a second screen having a first display area and a second display area; and
a control unit that switches the display unit, when one of the different functions is executed, to the first screen so as to display a piece of information relating to a job of the selected function, and when a job of a function that is not selected is inputted, switches the display unit to the second screen so as to display the piece of information relating to the job of the selected function on the first display area, and another piece of information relating to the inputted job of the not-selected function on the second display area.

2. The image forming apparatus according to claim 1, wherein
the control unit switches the display unit to the second screen so as to display pieces of information relating to jobs of different functions respectively on the first display area and the second display area, and when the job of the not-selected function is inputted, the piece of information displayed on the second display area is changed over to a piece of information relating to the inputted job.

3. The image forming apparatus according to claim 2, wherein
the control unit display units, every time the job of the not-selected function is inputted, the inputted job of the not-selected function on the second display area.

4. The image forming apparatus according to claim 3, further comprising:
job designation unit that designates one of jobs that are displayed on the second display area;
wherein the control unit, in response to the designation of the job from the job designation unit, stops the processing of the job that is currently being executed and performs interruption processing of the designated job.
